(19) United States
(12) Patent Application Publication
(10) Pub. No.: US 2009/0290112 A1
(43) Pub. Date: Nov. 26, 2009

(54) DISPLAY DEVICE

(75) Inventor: Takeshi SASAKI, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., Kanagawa (JP)

(21) Appl. No.: 12/511,650

(22) Filed: Jul. 29, 2009

(30) Foreign Application Priority Data
Jan. 8, 2008 (JP) 2008-199877

(51) Int. Cl. G02F 1/1335; G02B 27/00

(52) U.S. Cl. 349/137; 359/613

(57) ABSTRACT

A display device includes an optical member arranged on a display surface side of a display device, wherein the optical member comprises a plurality of concaves on a surface thereof, and wherein each of the concaves is formed with three planes crossing at right angles each other.

This application is based upon and claims the benefit of priority from Japanese patent application No. 2008-199877, filed on Aug. 1, 2008, the disclosure of which is incorporated herein in its entirety by reference.

### BACKGROUND OF THE INVENTION

1. Technical Field

The present invention relates to a display device.

2. Background Art

Liquid crystal display devices are widely used for LCD televisions and mobile terminals because of their capability for displaying high-quality image with reduced thickness and weight. Each of the liquid crystal displays includes a liquid crystal display panel and a backlight as a light source. The liquid crystal display panel includes a pair of glass substrates sandwiching liquid crystal and respective polarizer arranged on the outer side of each of the glass substrates.

In the aforementioned liquid crystal display, light transmits through the polarizer on the backlight side. The transmitted light is optically modulated within the liquid crystal display panel including the pair of the glass substrates. When the light is being transmitted through the polarizer on a display screen side (an observer side), the amount of the transmitted light depending on the modulation is emitted to the observer side. In such a display device displaying the image owing to the transmitted light from the backlight side, its display quality deteriorates when outside light enters the display surface side thereof. That is, because the outside light reflects at the polarizer on the display surface side, it is visually recognized eventually by the observer.

The deterioration of the display quality caused by the outside light will be described by referring to FIGS. 11A through 11C. FIGS. 11A through 11C are illustrations which schematically indicate a reflective state of the outside light in the display surface (specifically, the surface of the polarizer on the display surface side) of the display device.

With reference to FIG. 11A, a description is made as to a case that the polarizer has an untreated flat surface. In this case, an incident direction of the outside light is opposite to a reflective direction thereof as to the normal direction of the display surface. Its incident angle and reflective angle are the same angle. Therefore, a light source of the outside light is strongly reflected toward the observer from a particular area defined by that angle. As a result, the quality of picture degrades remarkably.

As an example of surface treatments for preventing such reflected glare of the outside light, there is a so-called anti-glare treatment as shown in FIG. 11B. The anti-glare treatment is also called as Anti-Glare or Non-Glare.

In the anti-glare treatment, the surface of the polarizer is coated with resi containing silica grain or the like having such large grain diameter as several microns. And thus the surface of tne polarizer is made rough state. As a result, it is made possible to reflect and scatter the incident light in various directions. Therefore, the reflected glare reduces when seen from the observer at the particular angle. Such anti-glare treatment is disclosed in Japanese Patent Application Laid-Open No. Hei-7 (1995)-181306 (hereinafter referred to as the patent document 1), for instance. The patent document 1 discloses a non-glare layer which has a minute relief structure containing convex portions with 5 to 20 points per 100 μm square such that each of the convex portions has a height of 0.5-2 μm measured from bottom of the adjacent concave portion on at least one surface of the non-glare layer.

As another example of the surface treatment, there is an anti-reflection treatment as shown in FIG. 11C. The anti-reflection treatment is also called as Anti-Reflection.

In the anti-reflection treatment, either an inorganic film layer or an organic film layer naving different refractive index is laminated so as to form multiple layers on the surface of the polarizer by using such method as a vapor deposition or a coating. And the incident light at the surface is reflected properly at an interface of each of the above-mentioned layers, respectively. Thus the reflected lights are interfered each other so as to decrease the total intensity of the reflected lights.

Such method is used for coating expensive optical lens and spectacle lens. For example, Japanese Patent Application Laid-Open No. Hei-4 (1992)-338901 (hereinafter referred to as the patent document 2) discloses a filter for CRT (Cathode Ray Tube) in which a surface film is provided on a plastic substrate. This surface film is formed such that a surface of an anti-reflective film made of either a single layer or multiple layers mainly consisting of silicon dioxide is covered with material consisting of silanol terminated organo polysiloxane.

Further, a retroreflective plate and a display device are disclosed in Japanese Patent Application Laid-Open No. 2004-045487 and Japanese Patent Application Laid-Open No. 2002-229017, respectively.

### SUMMARY

An exemplary object of the invention is to provide a display device which provides a high-quality image by suppressing influence of outside light.

A display device according to an exemplary aspect of the invention includes an optical member arranged on a display surface side of a display device, wherein the optical member comprises a plurality of concaves on a surface thereof, and wherein each of the concaves is formed with three planes crossing at right angles each other.

### BRIEF DESCRIPTION OF THE DRAWINGS

Exemplary features and advantages of the present invention will become apparent from the following detailed description when taken with the accompanying drawings in which:

FIG. 1 is a front view schematically showing a surface profile of a polarizer on a display surface side of a display device according to a first exemplary embodiment of the present invention;

FIG. 2 is an illustration schematically showing an optical path of the polarizer on the display surface side of the display device according to the first exemplary embodiment of the present invention;

FIG. 3 is a front view schematically showing the surface profile of the polarizer on the display surface side of the display device according to a second exemplary embodiment of the present invention;

FIG. 4 is an illustration schematically showing an optical path of the polarizer on the display surface side of the display device according to the second exemplary embodiment of the present invention;

FIG. 5 is a sectional view schematically showing the structure of the display device (a liquid crystal display) according to the second exemplary embodiment of the present invention;

FIG. 6 is a front view schematically showing the surface profile of the polarizer on the display surface side of the display device according to the second exemplary embodiment of the present invention;

FIG. 7 is an illustration schematically showing an optical path of the polarizer on the display surface side of the display device according to the second exemplary embodiment of the present invention;

FIG. 8 is a front view schematically showing the surface profile of the polarizer on the display surface side of the display device according to a third exemplary embodiment of the present invention;

FIG. 9 is a front view schematically showing the surface profile of the polarizer on the display surface side of the display device according to a fourth exemplary embodiment of the present invention;

FIGS. 10A through 10C are illustrations schematically showing an optical path of the polarizer on the display surface side of the display device according to the fourth exemplary embodiment of the present invention; and

FIGS. 11A through 11C are illustrations schematically showing an optical path of the polarizer on the display surface side of the display device according to a related art of the present invention.

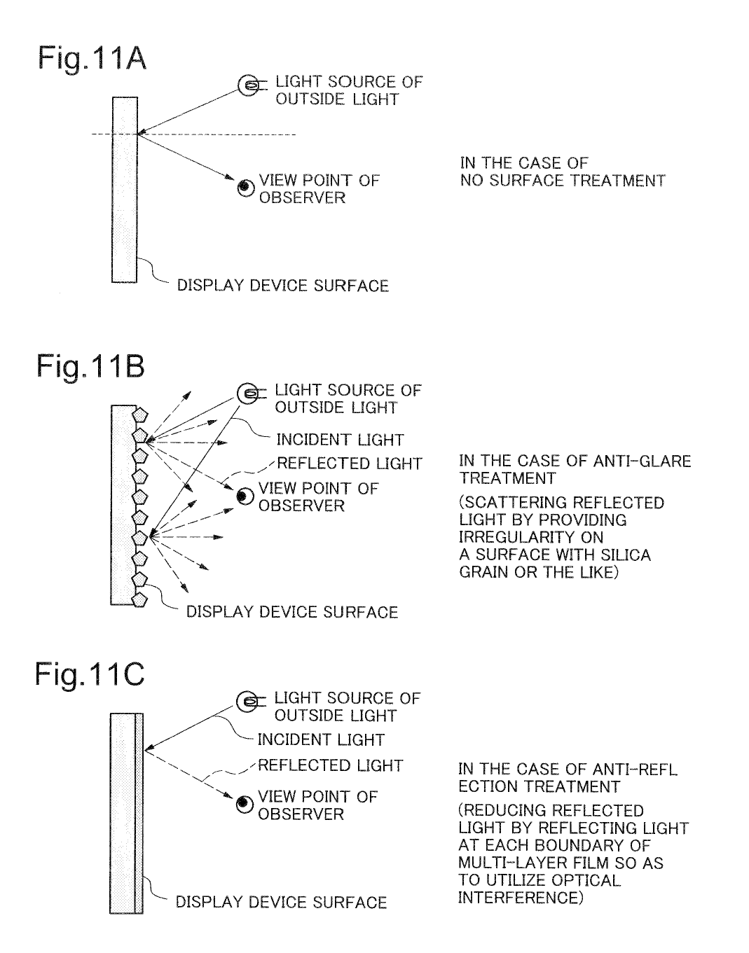

### EXEMPLARY EMBODIMENTS

### First Exemplary Embodiment

As indicated by the background art, in the case of the display device illuminated by the backlight, the outside light reflects at the surface of the polarizer. Therefore, there is a problem that its display quality deteriorates.

Regarding such problem, the patent documents 1 and 2 disclose methods for applying the anti-glare treatment and the anti-reflection treatment on the surface of the polarizer.

In the anti-glare treatment, however, because the outside light reflects diffusely in various directions to reduce contrast, a high-quality image is not obtained.

Specifically, in the anti-glare treatment, the outside light as the incident light is reflected in a scattering manner in various angles. Therefore, when it is viewed from the observer, the reflected light is observed from entire area on a display screen. Owing to this reflected light, an entire screen looks to be shone dimly. As a result, the contrast of a display image decreases.

On the other hand, in the anti-reflection treatment, because reflected glare is generated with color on the screen, the high-quality image is not obtained.

Specifically, in the anti-reflection treatment, optical interference is used. Therefore, reduction effect by the interference for the intensity of the reflected lights is different depending on wavelength of the outside light as the incident light. That is, the larger the deviation from targeted wavelength, the stronger the intensity of the reflected lights. Particularly, because it is usually designed so as to make the interference effect maximum by focusing on green wavelength which has high spectral luminous efficiency, purple and bluish light are tended to be reflected. When the light is incident from an oblique direction, effective film thickness, i.e., optical path length of each layer becomes long. Therefore, deviation occurs from correct phase interference so that the reflected light cannot be negated. From the foregoing reason, the reflected glare with color is generated on the screen.

In the case of the anti-reflection treatment, production cost is high and unevenness is tended to occur in the screen face.

In the anti-reflection treatment, it is necessary to form multiple layers by precisely controlling each film thickness of the layers having different refractive indexes as mentioned above. Therefore, its production cost is high and it is difficult to control the screen uniformly.

In this exemplary embodiment, accordingly, a surface profile of the display surface side of the display device is made by densely deploying such a structure having three planes crossing at right angles each other.

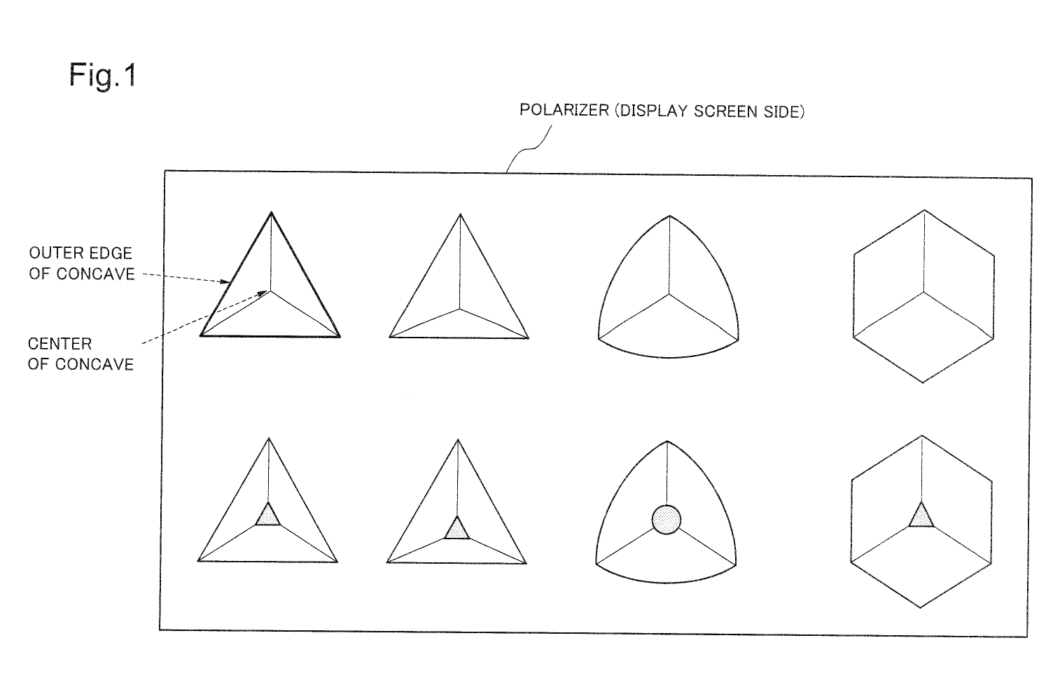

The structure of the display device of the first exemplary embodiment of the present invention will be described by referring to FIG. 1. As shown in FIG. 1, a display surface side of a display device in this exemplary embodiment is provided with an optical member having a plurality of concaves on a surface of the display surface side. Each of these concaves is formed with three planes crossing at right angles each other.

As a result, the outside light is reflected in the same direction of the incidence of the outside light. That is, by controlling the direction of the reflected light, the reflected glare of the outside light is prevented. The above-mentioned structure having three planes crossing at right angles each other may have such a structure of a triangular pyramid-like concave where the respective faces make the right angle, i.e., so-called a cube mirror or a corner cube. Other structure is also available where each center of the concave may be made flat rather than a concave point of the triangular pyramid. The outer edge of each concave may be designed to have such shape as a curved line shape and a polygonal shape. The position of the center of the concave has no preference, that is, it may be made identical or not identical with a centroid position of the shape made by the outer edge of the concave.

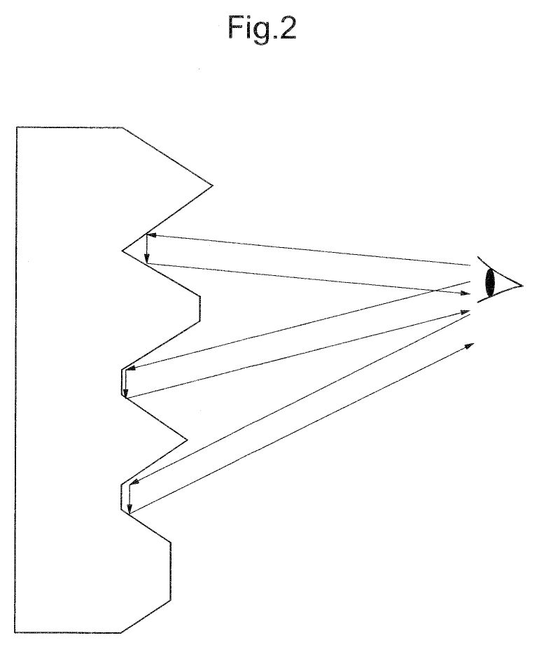

Referring to FIG. 2, more detailed description will be made as to function and effect of this exemplary embodiment.

As shown in FIG. 2, the reflecting direction of the light reflected at the surface of the display device of this exemplary embodiment is identical with the incidence direction of the outside light. This is because such concaves each consisting of three planes with their normal lines crossing each other in 90 degrees are densely deployed on the surface of the display surface side of the display device. As a result, when the outside light is reflected by the display surface of the display device, the reflected light is emitted toward the light source located on a line extending along the incidence direction of the incident light. Therefore, the reflected light does not enter the observer's eye in the position in which the inclined angle is different from the incidence direction. That is, when the route of the light which enters the observer's eye is followed reversely, the light source placed on an extended line of the route will certainly be the observer's eye itself. In other words, the one seen from the observer and looks reflected on the entire surface of the display device is the observer's eyes. Accordingly, the reflected glare such as the illumination and the sunlight which deteriorate the display quality does not occur.

As for the technology in relation to the present invention, there is a technology using the reflected light aggressively by utilizing the characteristic of a corner cube which reflects the light correctly for the light source direction.

In contrast, this exemplary embodiment focuses its attention on the reverse aspect of the above-mentioned characteristic. That is, the characteristic of the corner cube used in this exemplary embodiment is such characteristic that reflects the darkness corresponding to the light source correctly to the observer who is located on the direction of the light source when the observer's eye as the light source is dark.

Moreover, because the display device of this exemplary embodiment does not use the interference of the light, there are no dependences to the wavelength of the light. Therefore, coloring of the screen and the occurrence of irregular color can be suppressed.

The display device of this exemplary embodiment can prevent the decline of the contrast of the display image. This is because the outside light is reflected without being scattered.

From the foregoing reasons, the display device in this exemplary embodiment can achieve the high-quality image by suppressing the influence of the outside light.

Furthermore, the display device of this exemplary embodiment makes it possible to suppress unevenness of the display screen compared with the anti-reflection treatment. Further, it is possible to suppress a needed production cost. These are because it is not necessary to form multiple layers of different refractive indexes by precisely controlling each film thickness.

### Second Exemplary Embodiment

A second exemplary embodiment of the present invention is described below. A display device in this exemplary embodiment is that a display device of the first exemplary embodiment mentioned above is applied to a liquid crystal display. The liquid crystal display is a transmissive liquid crystal display, for instance.

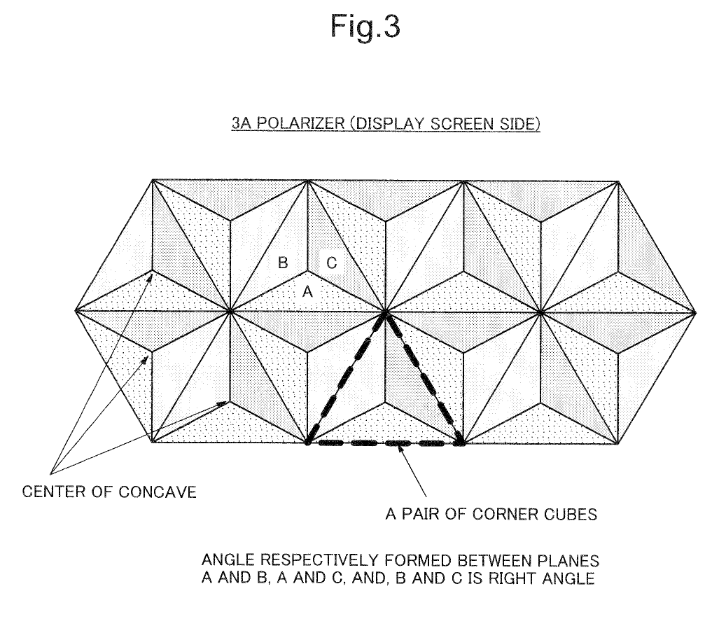

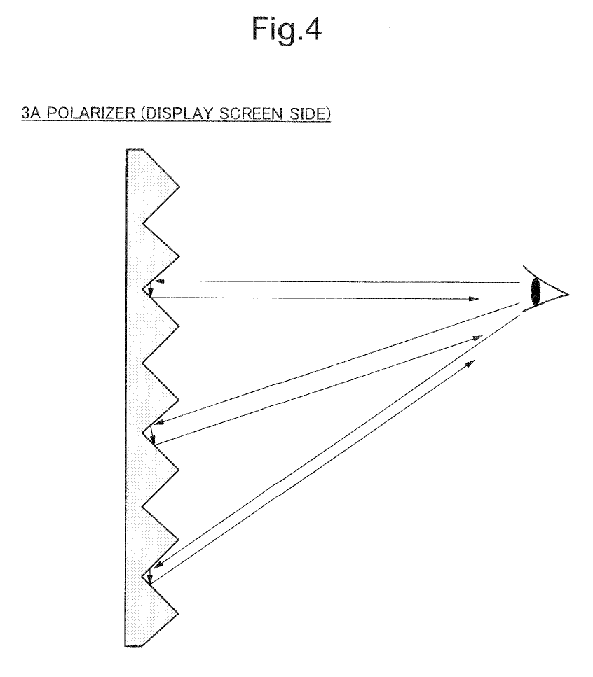

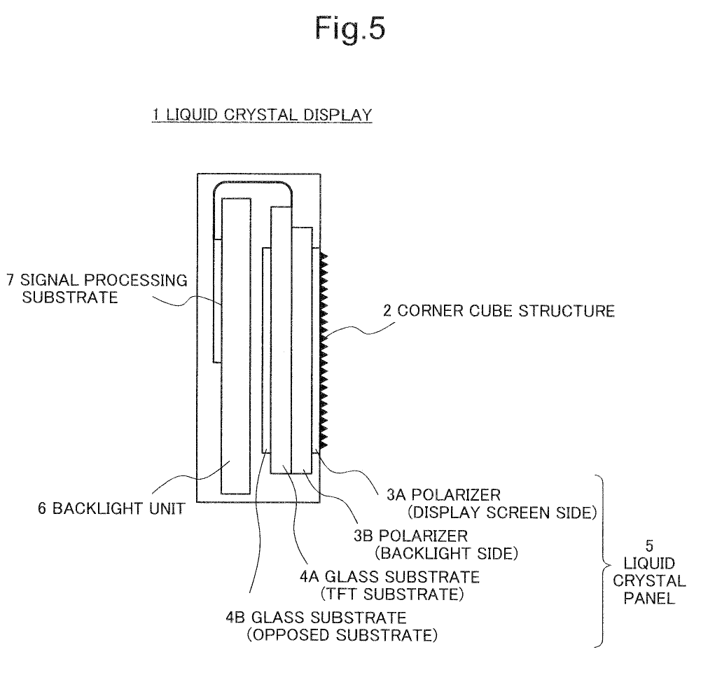

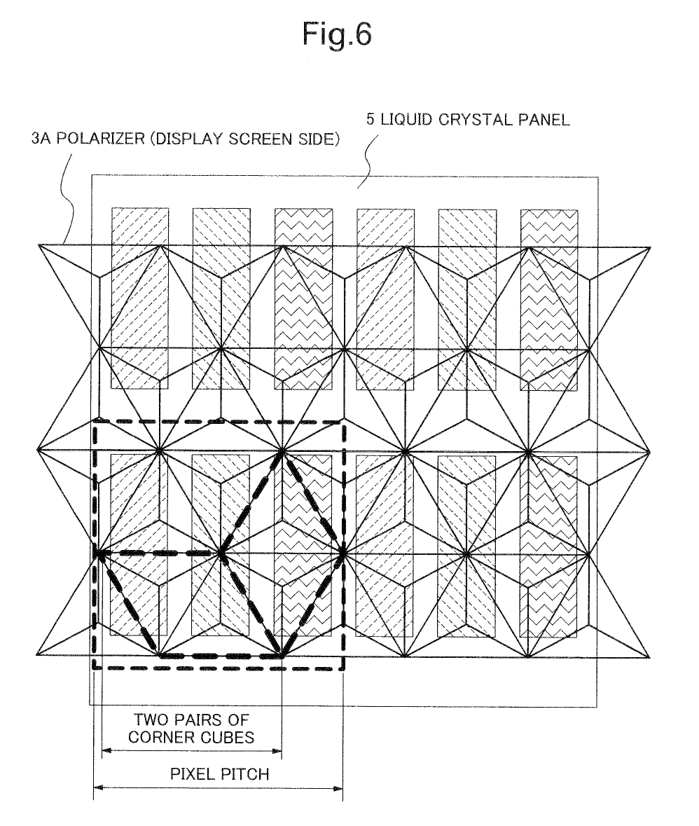

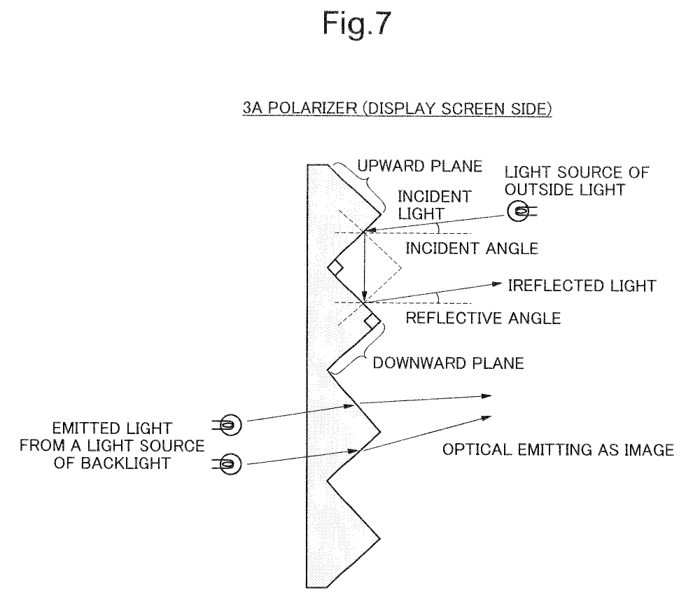

The structure of the liquid crystal display in this exemplary embodiment will be described with reference to FIG. 3 to FIG. 7. FIG. 5 is a sectional view which schematically indicates a structure of a liquid crystal display according to this exemplary embodiment. FIG. 3 and FIG. 6 are front views which schematically indicate the structure of a polarizer on the display surface side. FIG. 4 and FIG. 7 are illustrations schematically showing respective optical path of the polarizer on the display surface side of the display device.

As shown in FIG. 5, a liquid crystal display 1 of this exemplary embodiment includes a liquid crystal display panel 5, a backlight unit 6, a signal processing substrate 7 and a case. The backlight unit 6 illuminates the liquid crystal display panel. The signal processing substrate 7 drives the liquid crystal display panel 5. The case holds and fixes the signal processing substrate 7.

The backlight unit 6 includes a light source such as CCFL (Cold Cathode Fluorescent Lamp) and LED (Light Emitting Diode), an optical member and a case. The case holds and fixes optical members. The optical members include a reflector, a light-guiding plate, a diffusion sheet, and a sheet of lens.

The liquid crystal display panel 5 includes a glass substrate 4a (a TFT substrate: Thin Film Transistor substrate), a glass substrate 4b (an opposed substrate), liquid crystal, and an optical member such as a polarizer 3. Switching elements such as TFTs are formed on the glass substrate 4a (the TFT substrate) in a matrix shape. A color filter (CF) and a black matrix (BM) or the like are formed on the glass substrate 4b (the opposed substrate). The liquid crystal is sandwiched between the glass substrate 4a and the glass substrate 4b. The polarizer 3 includes two of the polarizer 3a and the polarizer 3b. The polarizer 3a is located on the display surface side that can be seen directly from the observer. The polarizer 3b is located on the backlight side between the glass substrate 4 and the backlight unit 6.

In the case of the liquid crystal display of aforementioned structure, the light emitted from the light source of the backlight unit 6 transmits through the polarizer 3b on the side of the backlight units 6. The transmitted light is optically modulated within the liquid crystal display panel including two glass substrates 4. And the modulated light transmits through the polarizer 3a on the display surface side. At that time, the amount of the transmitted light depending on the modulation is emitted to the observer side.

The polarizer 3 accomplishes its original function by transmitting the light through it as mentioned above. However, even if smaller refractive index material is selected as a surface film of the polarizer 3, its refractive index is different from air. Therefore, the reflection at the polarizer surface is inevitable.

In this exemplary embodiment, accordingly, the following feature is provided on the surface profile of the polarizer 3a on the display surface side of the polarizer 3. That is, the surface profile of this exemplary embodiment has cells as shown in FIG. 3. Each of the cells has a structure provided with a concave of a triangular pyramid. The concave has a shape which is obtained by pressing such a mold, which is produced by cutting a cube such that three planes sharing one vertex of the cube with diagonals not including the vertex, on the surface of the polarizer 3a from its vertex side. When viewed from the orthogonal direction of the polarizer 3a, the boundary line of this concave forms a plurality of equilateral triangles. That is, when seen from a top surface, one cell is an equilateral triangle made of three planes. Further, each side of the equilateral triangle is arranged so that it may overlap with one side of an adjacent equilateral triangle. That is, those cells are densely deployed on the entire surface without gap.

The structure of the cell mentioned above is generally the structure called cube mirror or the corner cube. Each of planes A, B and C of one of corner cube crosses at right angles each other. Therefore, in the corner cube, it is known that the incident light and the reflected light share the same direction of incidence and reflection correctly.

The surface profile of this exemplary embodiment may be formed into the polarizer 3a directly. Alternatively, the surface of the polarizer 3a may be pasted with a resin film or the like which is provided with the above-mentioned surface profile. As for the method for forming such surface profile, although it is possible to list various methods such as a press, a knurling, an injection molding, an etching, a photolithography and a milling, it is not limited to those methods.

It is not also limited about the pitch between the concaves. However, as shown in FIG. 6, it is desirable to make the arranged pitch of the concaves no more than ½ of an arranged pitch of pixels. Further, it is also desirable to provide no less than two corner cubes on every one pixel in vertically and horizontally. This is because it makes it possible to avoid the interference with the display pixel pitch of the liquid crystal display.

Moreover, as for such display in which a pixel array makes a straight line like in the liquid crystal display, it is desirable to provide an inclined angle no smaller than two degrees between a straight line of the pixel array direction and a straight line of a concave array direction. This is because it makes it possible to reduce moire in display.

Next, an operation of the liquid crystal display of this exemplary embodiment will be described by referring to FIG. 7. Because the surface of the polarizer 3a of this exemplary embodiment has a three-dimensional shape, description of the operation becomes complicated. Accordingly, for simplification, its concept will be described with reference to a two-dimensional illustration.

When a light penetrates through the polarizer 3a, emitting angle of the light changes owing to refraction at the surface of the polarizer 3a. However, its directivity is low because directions of the light emitted from the light source of the backlight have various angles. As a result, the polarizer 3a represents the same display view angle characteristic as a usual polarizer.

Next, the reflection of the outside light is described. A part of the outside light initially entered on a downward plane is transmitted into inside while the other part of it is reflected at the surface. This reflected light enters an upward plane as of another plane after the reflection. This incident light is reflected by the upward plane in the same direction of the incidence direction of the outside light toward the downward plane. At that time, the light is reflected toward opposite sense of the incident direction of the outside light toward the downward plane. Emitting angle of this reflected light is the same angle of incident angle of the outside light entered the downward plane.

The above-mentioned function is similar to the outside light which initially entered the upward plane. That is, after reflected by the upward plate, it is reflected again by the downward plane. This reflected light is emitted in the direction identical with the incidence direction of the outside light toward the upward plane.

Actually, the above-mentioned function is performed three-dimensionally in three planes. That is, after reflected at the surface of each plane, the light entering each plane is reflected by other two planes in order. And finally, the light will be reflected in the direction identical with the incidence direction of the outside light.

For example, the light entered a plane A, which is an arbitrary plane among three planes of the corner cube shown in FIG. 3, enters a plane B or a plane C after reflected by the plane A. The light which entered the plane B or the plane C is reflected by the plane B or the plane C and enters the plane C or the plane B. Finally, the light which entered the plane C or the plane B is reflected by the plane C or the plane B. The light reflected by plane C or the plane B is emitted in the direction identical with the incidence direction of the light toward the plane A. This kind of relation is effective in any incidence direction of the light entering the plane A

Accordingly, as shown in FIG. 4, when the route of the light which enters the observer's eyes is followed reversely, the emission direction of the light reflected at the surface of the polarizer 3a has tendency to be identical with the incidence direction of the light toward the polarizer 3a. Therefore, the light source which is located on an extended line of the route will certainly be the observer's eyes itself. In other words, in view of the observer, the display device reflects the eyes of the observer. Accordingly, the reflected glare such as the illumination and the sunlight which deteriorate the display quality can be suppressed.

In this exemplary embodiment, accordingly, a surface profile of the polarizer 3a on the display surface side of the display device is made by densely deploying triangular pyramid-like concaves each having three planes crossing at right angles each other. As a result, the light emitted from a light source of the backlight can be transmitted substantially through the polarizer. Because the outside light is reflected in the direction identical with the incidence direction thereof, the outside light is not visually recognized by the observer. Therefore, it is possible to suppress the reflected glare of the outside light on the display surface. Furthermore, coloring of the screen and the occurrence of the irregular color can be suppressed.

Being different from the anti-glare treatment, the contrast of the image does not decline because the outside light is reflected without being scattered.

From the foregoing reasons, the liquid crystal display in this exemplary embodiment can achieve the high-quality image by suppressing the influence of the outside light.

Moreover, the liquid crystal display in this exemplary embodiment does not need to form multiple layers of different refractive indexes obtained by precisely controlling each film thickness, which is needed in the anti-reflection treatment. And thus it makes it possible to decrease unevenness of the display screen compared with that obtained by the anti-reflection treatment. Furthermore, it is possible to reduce a needed production cost compared with the case resorting to the anti-reflection treatment.

Moreover, in the liquid crystal display in this exemplary embodiment, a surface having the concaves is located on the outermost surface on the display surface side of the liquid crystal display. Accordingly, being compared with such a display device which reflects the outside light inside an optical member, it is possible to steadily suppress the influence of the outside light without adjustment or the like of refractive index of the optical member.

### Third Exemplary Embodiment

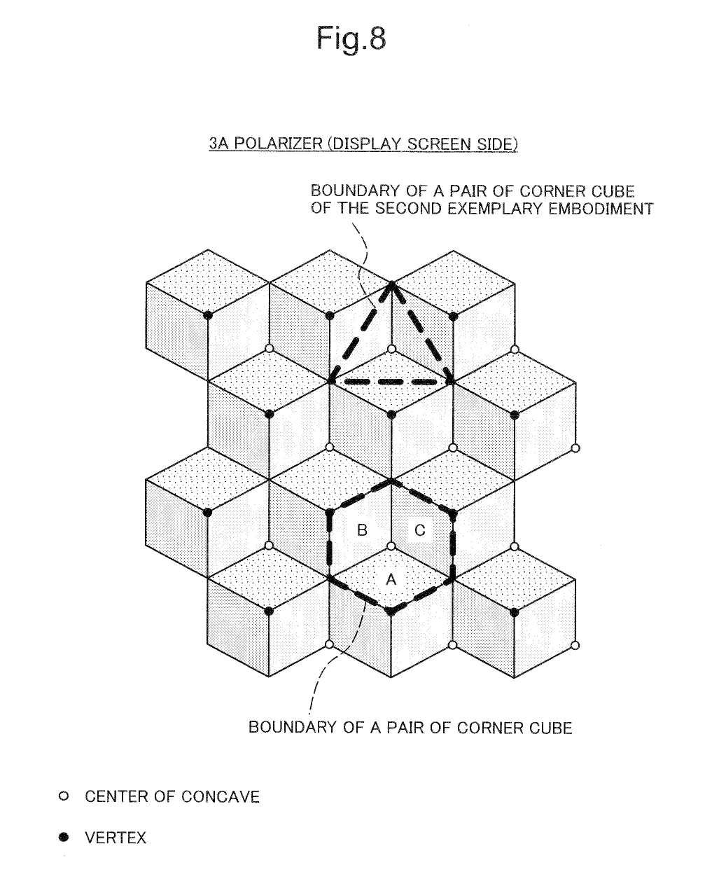

Next, a display device according to a third exemplary embodiment of the present invention will be described by referring to FIG. 8. FIG. 8 is a front view which schematically indicates a structure of a polarizer on the display surface side of the liquid crystal display of this exemplary embodiment.

According to the second exemplary embodiment, the surface of the polarizer 3a on the display surface side is provided with the structure that arranged the concaves of the triangular pyramids. In contrast, as shown in FIG. 8, the surface profile of this exemplary embodiment has such structure that three planes of each of corner cubes are arranged so as to be appear on a surface. A boundary of a pair of corner cubes consists of three square planes and represents a shape of the regular hexagon when it seen from the front.

That is, boundary lines of the concaves in this exemplary embodiment represent a plurality of regular hexagons when it viewed from a normal line direction of the optical member. The concaves are arranged so that each side of the regular hexagon overlaps with one side of an adjacent regular hexagon.

Each of the concaves in this exemplary embodiment has a configuration represented by pressing a mold having three planes sharing one vertex of a cube on surface of the polarizer 3a from its vertex side.

According to this exemplary embodiment, the boundary of a pair of corner cubes can be reduced to half compared with the second exemplary embodiment. Therefore, an area for seam part of each plane that cannot control the reflecting direction can be reduced to half. As a result, the higher-quality image can be obtained.

When the boundary line of the above-mentioned corner cube is regarded as a minute plane, the reflection at the plane will be usual reflection like a condition that no surface treatment is made on a display screen.

In the second exemplary embodiment, angles of the above-mentioned boundary lines are arrayed on the same flat surface. Therefore, a reflected glare of the light from a particular angle is tended to occur. However, according to this exemplary embodiment, the boundary lines are not arrayed on the same flat surface but they are dispersed on straight lines in three directions arranged to form right angles each other. Therefore, a reflected glare light quantity from a particular angle can be reduced to approximately ⅓. As a result, a higher-quality image can be obtained.

### Fourth Exemplary Embodiment

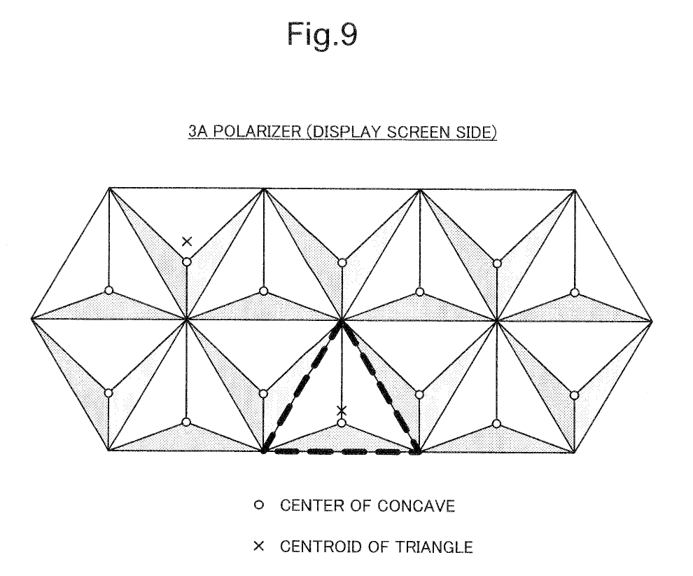

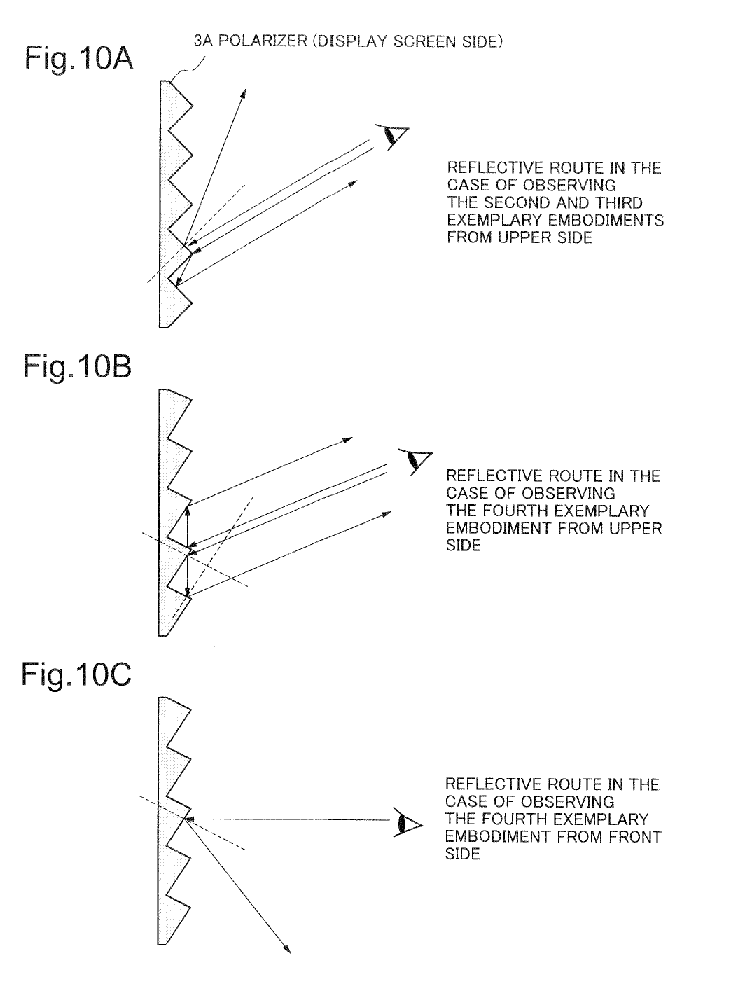

Next, a display device according to a fourth exemplary embodiment of the present invention will be described by referring to FIG. 9 and FIGS. 10A through 10C. FIG. 9 is a front view which schematically indicates a structure of a polarizer on a display surface side of a liquid crystal display of this exemplary embodiment. FIGS. 10A through 10C are illustrations schematically indicating an optical path at a polarizer on a display surface side.

According to the second exemplary embodiment, as shown in FIG. 3, the position of the center of the concave of each corner cube will be the center of the opening of the corner cube. In contrast, in this exemplary embodiment, the position of the center of the concave of each corner cube shown in FIG. 3 is shifted from a centroid position of a graphic formed by boundary lines of concaves to an appropriate direction.

Specifically, as shown in FIG. 9, the center of the concave of each corner cube is located at position lower than the centroid position of the opening of the cube corner, i.e., of the opening of a triangle expressed in a broken line shown in FIG. 3.

That is, the position where three planes are crossed each other, i.e., the center of the concave in this exemplary embodiment, is shifted from a centroid position of a graphic formed by boundary lines of the concaves to a predetermined direction when it viewed from a normal line direction of the polarizer.

The liquid crystal display with such structure of the second and third exemplary embodiments is described for the case which is observed from a position higher than the direction vertical to the display surface. In a case shown in FIG. 10A, a small proportion of the light may not reflect three times by the corner cube. That is, the reflection may happen only once. In this case, the observer will see the light of the light source located at a position of direction different from the observer.

When a computer screen is observed actually, the screen is often peered down from the top. Therefore, the above-mentioned phenomenon will be a factor which degrades a display quality.

In this exemplary embodiment, as shown in FIG. 10B, the angle of the corner cube is set to meet a direction where the observer usually uses. As a result, reflections besides the direction of the observer are generated from no parts of the corner cube.

In the above-mentioned structure, when the display observed from a vertical direction of the screen, a small proportion of the light may not reflect three times by the corner cube but reflects only once like in the case shown in FIG. 10A. In this case, the observer will see the light of the light source located at a position of direction different from the observer.

However, as shown in FIG. 10C, its direction will be always lower than the position of the observer. Therefore, as far as there are no light sources with high luminance in the observer's lower part, no trouble occur practically. The light sources causing the reflected glare which degrades the display quality is usually illumination or the sunlight. However, in most cases, these light sources are located higher than the observer. Therefore, when the display surface of the liquid crystal display is designed to have the structure shown in FIG. 10B, these light sources do not reflect on the screen.

Although the polarizer shown in FIG. 9 is the structure obtained by shifting the center position of the concave of each corner cube of the polarizer shown in FIG. 3, it is not limited to this. That is, it may be such structure where the center position of the concave of each corner cube of the polarizer in the third exemplary embodiment shown in FIG. 8 is shifted.

The center position of the concave of each corner cube of this exemplary embodiment does not need to be the same position on an entire screen. That is, at the upper part of the screen, its angle can be arranged to have angle close to the case shown in the second and third exemplary embodiments while at a lower part of the screen, it can be arranged to have such angle as in the case of the fourth exemplary embodiment. In an actual usage condition, such arrangement makes an arrangement angle the most suitable for the corner cube at every position on the display screen. Therefore, there is an advantage to expand a range of preventing the reflected glare of the light source which causes the degradation of the display quality.

### Fifth Exemplary Embodiment

A fifth embodiment of the invention is that the display device according first exemplary embodiment, wherein each of the concaves has a configuration represented by pressing a mold, which is provided by cutting a cube such that three surfaces sharing one vertex of said cube with diagonals not including the vertex, on the surface of the optical member from its vertex side.

Therefore, boundary lines of the concaves form a plurality of equilateral triangles, and the concaves are arranged such that each side of the equilateral triangle is arranged to overlap with one side of an adjacent equilateral triangle.

### Sixth Exemplary Embodiment

A sixth embodiment of the invention is that the display device according first exemplary embodiment, wherein each of the concaves has a configuration represented by pressing a mold having three planes sharing one vertex of a cube on the surface of the optical member from its vertex side.

Therefore, the boundary lines of the concaves represent a plurality of regular hexagons, and the concaves are arranged so that each side of the regular hexagon overlaps with one side of an adjacent regular hexagon.

### Seventh Exemplary Embodiment

A seventh embodiment of the invention is that the display device according first exemplary embodiment, wherein a position where the three planes are crossed each other is shifted from a centroid position of a graphic formed by boundary lines of the concaves to an appropriate direction,

### Eighth Exemplary Embodiment

An eighth embodiment of the invention is that the display device according first exemplary embodiment, wherein the optical member is disposed on a display surface side of a display panel provided with pixels arranged in matrix, and an arranged pitch of the concaves is set to be no more than ½ of an arranged pitch of the pixels.

### Ninth Exemplary Embodiment

A ninth embodiment of the invention is that the display device according first exemplary embodiment, wherein the optical member is disposed on a display surface side of a display panel provided with pixels arranged in matrix, and an inclined angle formed between an array direction of the concaves and an array direction of the pixels is set to be no smaller than two degrees.

### Tenth Exemplary Embodiment

A tenth embodiment of the invention is that the display device according first exemplary embodiment, wherein the display device is a transmissive liquid crystal display, and the optical member is a polarizer.

### Eleventh Exemplary Embodiment

A eleventh embodiment of the invention is that the display device according first exemplary embodiment, wherein the display device is a transmissive liquid crystal display, and the optical member is a polarizer pasted with a resin film provided with the concave.

According to each above-mentioned exemplary embodiment, although the shape of each concave is formed by pressing a cube, its shape is not limited to this. That is, the shape of each concave may be made by pressing a rectangular parallelepiped.

According to each above-mentioned exemplary embodiment, although its description is made about the surface profile of the polarizer on the display surface side, it is not limited to this. That is, the surface profile of the present invention can be applied to any kind of optical member so long as it has a problem caused by its reflection.

According to each above-mentioned exemplary embodiment, although it has been described taking the liquid crystal display for instance, it is not limited to this. that is, the present invention can be also applied to an arbitrary display device in the same manner so long as it has a problem caused by its reflection on the display surface side.

While this invention has been described in connection with certain exemplary embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

Further, it is the inventor's intent to retain all equivalents of the claimed invention even if the claims are amended during prosecution.

1. A display device comprising:
an optical member arranged on a display surface side of a display device,
wherein said optical member comprises a plurality of concaves on a surface thereof, and
wherein each of said concaves is formed with three planes crossing at right angles each other.

2. The display device according to claim 1, wherein each of said concaves has a configuration represented by pressing a mold, which is provided by cutting a cube such that three surfaces sharing one vertex of said cube with diagonals not including said vertex, on said surface of said optical member from its vertex side.

3. The display device according to claim 1, wherein boundary lines of said concaves form a plurality of equilateral triangles, and
wherein said concaves are arranged such that each side of said equilateral triangle is arranged to overlap with one side of an adjacent equilateral triangle.

4. The display device according to claim I wherein each of said concaves has a configuration represented by pressing a mold having three planes sharing one vertex of a cube on said surface of said optical member from its vertex side.

5. The display device according to claim 1, wherein boundary lines of said concaves represent a plurality of regular hexagons, and
wherein said concaves are arranged so that each side of said regular hexagon overlaps with one side of an adjacent regular hexagon.

6. The display device according to claim 1, wherein a position where said three planes are crossed each other is shifted from a centroid position of a graphic formed by boundary lines of said concaves to an appropriate direction.

7. The display device according to claim 1, wherein said optical member is disposed on a display surface side of a display panel provided with pixels arranged in matrix, and
wherein an arranged pitch of said concaves is set to be no more than ½ of an arranged pitch of said pixels.

8. The display device according to claim 1, wherein said optical member is disposed on a display surface side of a display panel provided with pixels arranged in matrix, and
wherein an inclined angle formed between an array direction of said concaves and an array direction of said pixels is set to be no smaller than two degrees.

9. The display device according to claim 1, wherein said display device is a transmissive liquid crystal display, and said optical member is a polarizer.

10. The display device according to claim 1, wherein said display device is a transmissive liquid crystal display, and said optical member is a polarizer pasted with a resin film provided with said concave.
